(19) United States
(12) Patent Application Publication
(10) Pub. No.: US 2014/0062922 A1
(43) Pub. Date: Mar. 6, 2014

(54) Touch Sensing Device and Touch Point Locating Method Thereof

(71) Applicant: NOVATEK Microelectronics Corp., Hsin-Chu (TW)

(72) Inventor: Wing-Kai Tang, Hsinchu City (TW)

(73) Assignee: NOVATEK Microelectronics Corp., Hsin-Chu (TW)

(21) Appl. No.: 13/965,218

(22) Filed: Aug. 13, 2013

(30) Foreign Application Priority Data
Aug. 31, 2012 (TW) 101131878

(51) Int. Cl. G06F 3/041

(52) U.S. Cl. CPC G06F 3/041
USPC 345/173

(57) ABSTRACT

A touch sensing device includes a plurality of first dimensional transparent electrodes and a plurality of second dimensional transparent electrodes, for forming a plurality of touch sensing points; one or more signal generators, for generating at least two orthogonal signals simultaneously coupled to at least two of the plurality of first dimensional transparent electrodes; one or more analog to digital converters for receiving a plurality of sensing signals from the plurality of second dimensional transparent electrodes; and one or more calculating units, for converting the plurality of sensing signals, to determine components of the at least two orthogonal signals in the plurality of sensing signals and locates at least one touch point on the plurality of touch sensing points.

### BACKGROUND OF THE INVENTION

1. Field of the Invention

The present invention relates to a touch sensing device and related touch point locating method, and more particularly, to a touch sensing device and related touch point locating method, capable of sending a plurality of distinguishable signals simultaneously for sensing, and determining each component of the plurality of distinguishable signals in sensing signals to locate touch points rapidly.

2. Description of the Prior Art

In general, a touch point locating method of a conventional touch sensing device utilizes time-domain scanning signals in coordination with scanning timing to capture panel sensing signals, and takes a scanning order as a corresponding arranged location for locating. For example, please refer to FIG. 1 and FIG. 2. FIG. 1 illustrates a schematic diagram of a conventional touch sensing device 10. FIG. 2 illustrates a schematic diagram of scanning clock signals w(1)-w(k) and a timing synchronization signal Syn shown in FIG. 1. As shown in FIG. 1, the touch sensing device 10 includes a touch sensing panel 100, a pulse signal generator 102, a analog to digital converter (ADC) 104, and a microprocessor 106. In short, the touch sensing panel 100 includes vertical transparent electrodes Tc(1)-Tc(k) and horizontal transparent electrodes Tr(1)-Tr(j) to form touch sensing points T(1,1)-T(j,k). Besides, the conventional transparent electrodes are mostly a structure of Indium Tin Oxide (ITO), which is a mixture composed of 90% In₂O₃ and 10% SnO₂, but also can be implemented by fine (not visible to eyes) metal wires.

Next, as shown in FIG. 1 and FIG. 2, when the conventional touch sensing device 10 performs time-domain scanning locating, the pulse signal generator 102 sequentially generates the scanning clock signals w(1)-w(k) to the vertical transparent electrodes Tc(1)-Tc(k) and generates the timing synchronization signal Syn to the analog to digital converter 104 according to a clock signal clk, such that the analog to digital converter 104 can receive sensing signals s(1)-s(j) from the horizontal transparent electrodes Tr(1)-Tr(j) according to the timing synchronization signal Syn and performs analog to digital conversion. Then, the microprocessor 106 determines corresponding touch sensing point signals P(1,1)-P(j,k) of touch sensing points T(1,1)-T(j,k). For example, when the microprocessor 106 determines the current output scanning clock signal w(m) corresponding to the vertical transparent electrode Tc(m) according to the timing synchronization signal Syn, the received sensing signals s(1)-s(j) represent the corresponding touch sensing point signals P(1,m)-P(j,m) of the touch sensing points T(1,m)-T(j,m) (i.e. the touch sensing points on the vertical transparent electrode Tc(m)). Finally, after the pulse signal generator 102 sequentially generates scanning clock signals w(1)-w(k) to scan the vertical transparent electrodes Tc(1)-Tc(k), the microprocessor 106 determines touch points occurring on which of the touch sensing points T(1,1)-T(j,k) according to the intensity of the touch sensing point signals P(1,1)-P(j,k).

However, when the conventional touch sensing device 10 performs time-domain scanning locating, since the conventional touch sensing device 10 needs to utilize the scanning clock signals w(1)-w(k) to scan the vertical transparent electrodes Tc(1)-Tc(k) one by one and needs to capture information of the sensing signals s(1)˜s(j) in coordination with the timing synchronization signal Syn, the determining speed is slow and the sensing signals are easy to be interfered. Thus, there is a need for improvement of the prior art.

### SUMMARY OF THE INVENTION

It is therefore an objective of the present invention to provide a touch sensing device and relative touch point locating method, which is capable of generating a plurality of distinguishable signals simultaneously to perform sensing, and determines each component of the plurality of distinguishable signals in sensing signals to locate touch points rapidly.

The present invention discloses a touch sensing device comprising a touch sensing panel, comprising a plurality of first dimensional transparent electrodes and a plurality of second dimensional transparent electrodes, for forming a plurality of touch sensing points; one or more signal generators, for generating at least two orthogonal signals simultaneously coupled to at least two of the plurality of first dimensional transparent electrodes; one or more analog to digital converters(ADC), coupled to the plurality of second dimensional transparent electrodes, for receiving a plurality of sensing signals from the plurality of second dimensional transparent electrodes; and one or more calculating units, for converting the plurality of sensing signals, to determine components of the at least two orthogonal signals in the plurality of sensing signals and locate at least one touch point on the plurality of touch sensing points.

The present invention further discloses a touch sensing device comprising a touch sensing panel, comprising a plurality of first dimensional transparent electrodes and a plurality of second dimensional transparent electrodes, for forming a plurality of touch sensing points; one or more signal generators, for generating at least two periodic wave signals simultaneously coupled to at least two of the plurality of first dimensional transparent electrodes; one or more analog to digital converters(ADC), coupled to the plurality of second dimensional transparent electrodes, for receiving a plurality of sensing signals from the plurality of second dimensional transparent electrodes; and one or more calculating units, for converting the plurality of sensing signals, to determine components of the at least two periodic wave signals in the plurality of sensing signals and locates at least one touch point on the plurality of touch sensing points.

The present invention further discloses a touch point locating method, for a touch sensing device, comprising generating at least two distinguishable signals simultaneously coupled to at least two of a plurality of first dimensional transparent electrodes; receiving a plurality of sensing signals from a plurality of second dimensional transparent electrodes; converting the plurality of sensing signals, to determine components of the at least two distinguishable signals in the plurality of sensing signals; and locating at least one touch point on a plurality of touch sensing points formed by the plurality of first dimensional transparent electrodes and the plurality of second dimensional transparent electrodes.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram of a conventional touch sensing device.

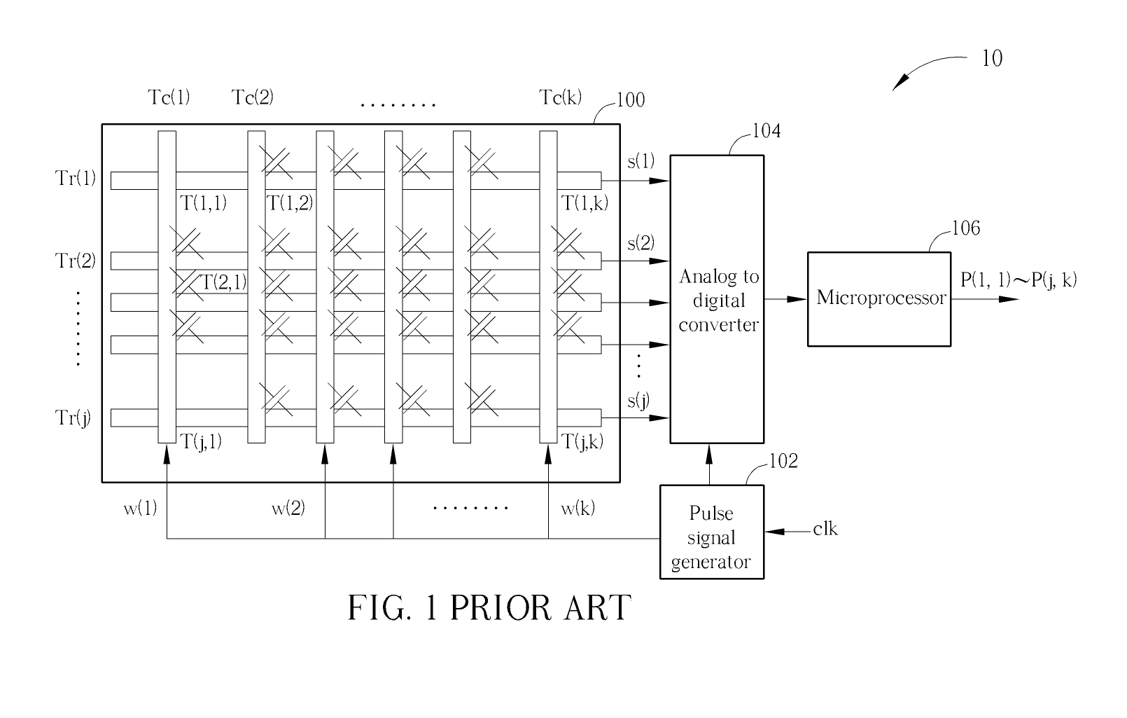

FIG. 2 illustrates a schematic diagram of scanning clock signals shown in FIG. 1 and a timing synchronization signal.

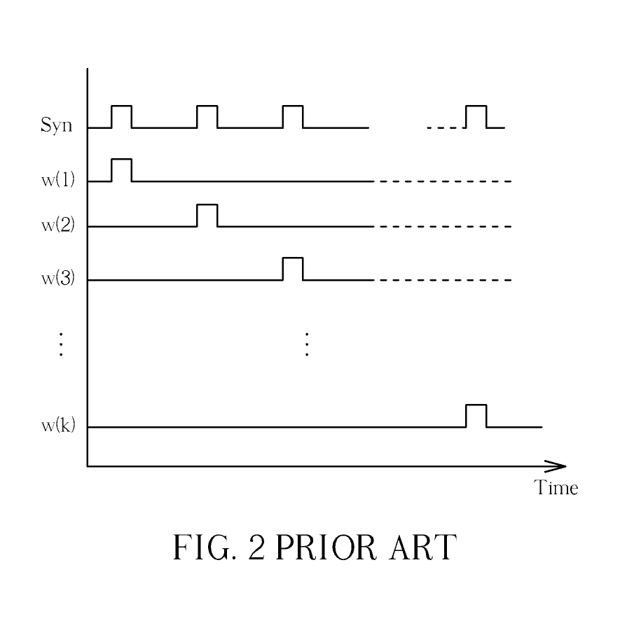

FIG. 3 illustrates a schematic diagram of a touch sensing device according to an embodiment of the present invention.

FIG. 4 illustrates a schematic diagram of distinguishable signals shown in FIG. 3 when the distinguishable signals are periodic wave signals with different frequencies.

FIG. 5 illustrates a schematic diagram of sensing signals shown in FIG. 3 when distinguishable signals are periodic wave signals with different frequencies.

FIG. 6 illustrates a schematic diagram of converting a sensing signal by a calculating unit shown in FIG. 3.

FIG. 7 illustrates a schematic diagram of a touch point locating process according to an embodiment of the present invention.

### DETAILED DESCRIPTION

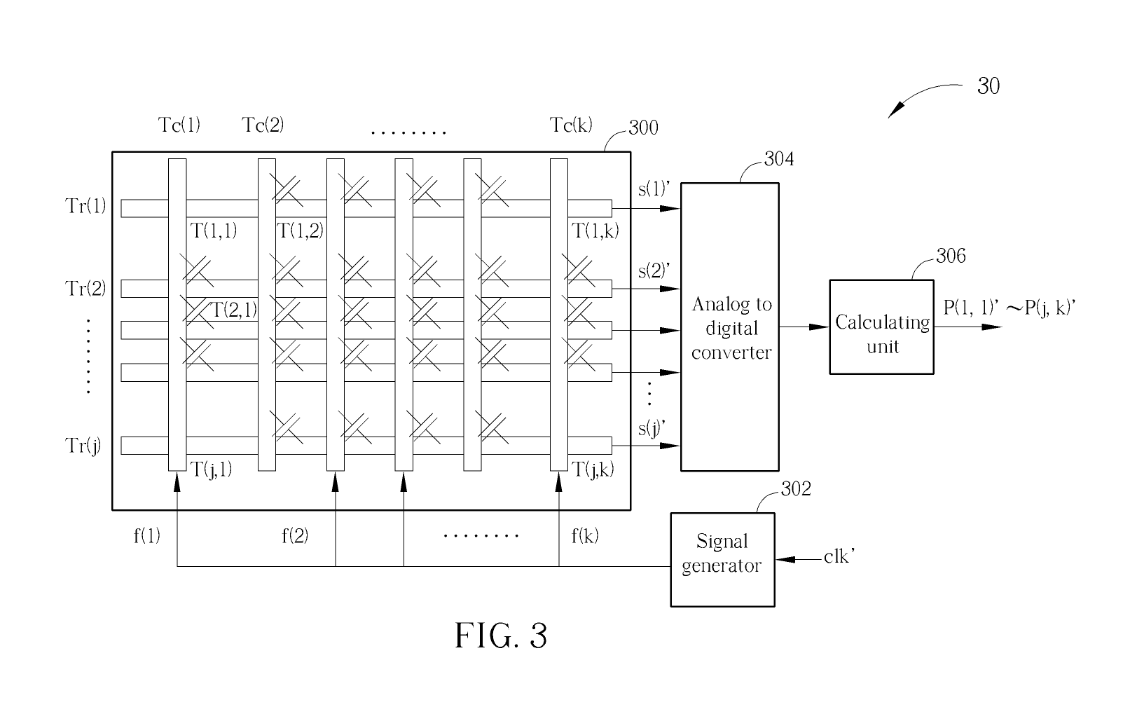

Please refer to FIG. 3, which illustrates a schematic diagram of a touch sensing device 30 according to an embodiment of the present invention. As shown in FIG. 3, the touch sensing device 30 includes a touch sensing panel 300, a signal generator 302, an analog to digital converter (ADC) 304 and a calculating unit 306. In short, since the touch sensing panel 300 and the touch sensing panel 100 are partially similar, elements and signals with the same functions are denoted by the same symbols. The touch sensing panel 300 includes vertical transparent electrodes Tc(1)-Tc(k) and horizontal transparent electrodes Tr(1)-Tr(j) to form touch sensing points T(1,1)-T(j,k). The signal generator 302 generates distinguishable signals f(1)-f(k) simultaneously coupled to the vertical transparent electrodes Tc(1)-Tc(k) according to a clock signal clk′. The analog to digital converter 304 is coupled to the horizontal transparent electrodes Tr(1)˜Tr(j) for receiving sensing signals s(1)′-s(j)′ from the horizontal transparent electrodes Tr(1)-Tr(j) and performs analog to digital conversion. The calculating unit 306 converts the sensing signals s(1)′-s(j)′ to determine components of the distinguishable signals f(1)˜f(k) in the sensing signals s(1)′-s(j)′, to decide corresponding touch sensing point signals P(1,1)′-P(j,k)′ of the touch sensing points T(1,1)-T(j,k), and then locates at least one touch point on the touch sensing points T(1,1)-T(j,k).

In such a condition, since the calculating unit 306 can determine the components of the distinguishable signals f(1)-f(k) in the sensing signals s(1)′-s(j)′, the distinguishable signals f(1)-f(k) can be simultaneously coupled to the vertical transparent electrodes Tc(1)-Tc(k) for the calculating unit 306 to perform following determination. Thus, the present invention does not need to sequentially scan the vertical transparent electrodes Tc(1)˜Tc(k) as the prior art. As a result, the present invention can simultaneously couple the distinguishable signals f(1)˜f(k) to the vertical transparent electrodes Tc(1)˜Tc(k) and does not need to sequentially scan the vertical transparent electrodes Tc(1)˜Tc(k), and then receives and converts the sensing signal s(1)′-s(j)′ all the time to determine the touch point location according to the components of the distinguishable signals f(1)˜f(k), and does not need to coordinate with synchronization. Therefore, a speed of touch determination can be increased.

In detail, the distinguishable signals f(1)-f(k) can be orthogonal signals which are orthogonal to each other or signals with other distinguishable characteristics, and then the calculating unit 306 determines the components of the distinguishable signals f(1)-f(k) in the sensing signals s(1)′-s(j)′ according to the orthogonal characteristic or the other distinguishable characteristics. For example, the distinguishable signals f(1)-f(k) can be periodic wave signals which are orthogonal to each other, such as periodic wave signals with different frequencies or periodic wave signals with a same frequency and a phase difference of 90 degree, and then the calculating unit 306 analyzes a spectrum and a phase of the sensing signals s(1)′-s(j)′ to determine the components of the distinguishable signals f(1)-f(k).

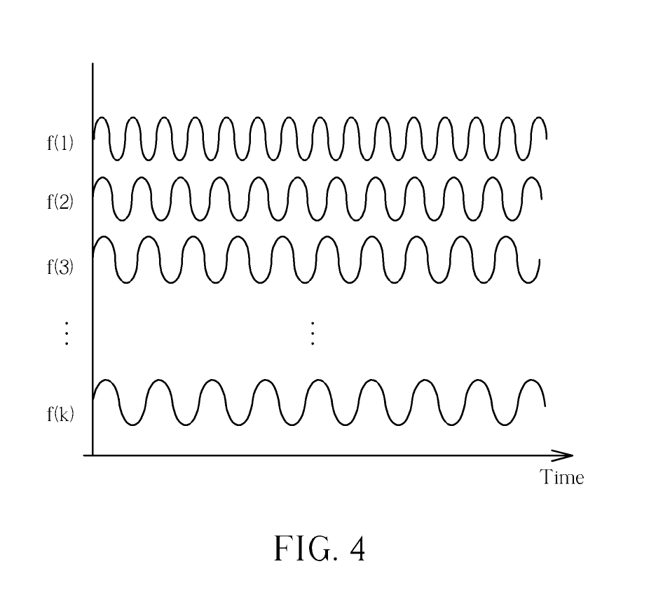

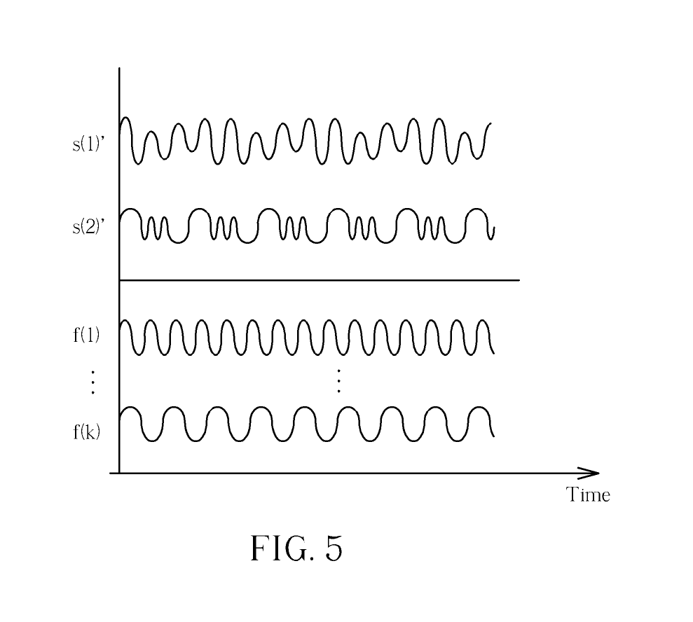

For example, please refer to FIG. 4 and FIG. 5. FIG. 4 illustrates a schematic diagram of the distinguishable signals f(1)-f(k) shown in FIG. 3 when the distinguishable signals f(1)-f(k) are periodic wave signals with different frequencies. FIG. 5 illustrates a schematic diagram of the sensing signal s(1)′-s(j)′ shown in FIG. 3 when the distinguishable signals f(1)-f(k) are periodic wave signals with different frequencies(sine wave signals in this example). As shown in FIG. 4 and FIG. 5, since the distinguishable signals f(1)-f(k) are simultaneously coupled to the vertical transparent electrodes Tc(1)-Tc(k), the sensing signals (1)′-s(j)′ generated from the horizontal transparent electrodes Tr(1)˜Tr(j) due to the touch points superimposing a portion of the distinguishable signals f(1)-f(k) are different as the touch point location varies(since the vertical transparent electrode corresponding to the touch point on the horizontal transparent electrode Tr(1) and the vertical transparent electrode corresponding to the touch point on the horizontal transparent electrode Tr(j) are different, the waveforms of the accumulating sensing signals s(1)′-s(j)′ are also different).

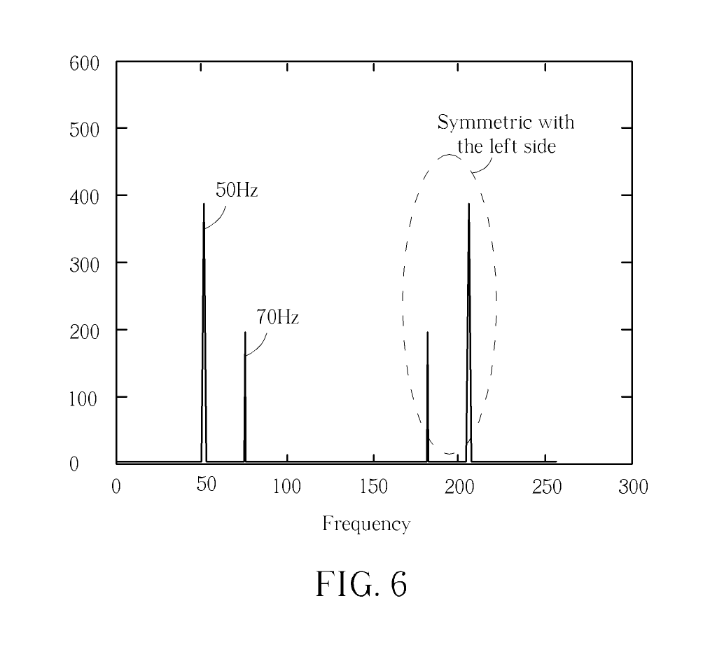

In such a condition, please refer to FIG. 6, which illustrates a schematic diagram of the calculating unit 306 shown in FIG. 3 performing conversion on the sensing signal s(1)′. As shown in FIG. 6, if the distinguishable signals f(1)-f(k) generated by the signal generator 302 are periodic wave signals with frequencies of 10 Hz, 20 Hz, 30 Hz, . . . , (100*k)Hz. When two touch points locates on touch sensing points T(1,5) and T(1,7), which are intersection points of the horizontal transparent electrode Tr(1) and the vertical transparent electrodes Tc(5) and Tc(7), the calculating unit 306 converts the sensing signal s(1)′, which is captured from the horizontal transparent electrode Tr(1), from time-domain to frequency-domain to obtain spectrum signals shown in FIG. 6. The signals appear at frequencies of 50 Hz and 70 Hz (the right side signals are the symmetrical signals generated by conversion). Therefore, the calculating unit 306 can obtain the touch points occurring on the touch sensing points T(1,5) and T(1,7), which are intersections of the horizontal transparent electrode Tr(1) and the vertical transparent electrodes Tc(5) and Tc(7).

The above calculation of the calculating unit 306 converting the sensing signal s(1)′ from time-domain to frequency-domain can be implemented by discrete fourier transform (DFT) or fast fourier transform (FFT). Since only specific frequency responses are meaningful (for example, the frequencies of 10 Hz, 20 Hz, 30 Hz, . . . , (100*k)Hz, which are related to the distinguishable signals f(1)-f(k)), only the specific frequencies are required to be calculated for simplifying calculating complexity. Fast fourier transform is the calculating method of discrete fourier transform with high efficiency, and discrete fourier transform and fast fourier transform are familiar to those skilled in the art and will not be narrated hereinafter.

Noticeably, the spirit of the present invention is to simultaneously couple the distinguishable signals to the vertical transparent electrodes and not need to sequentially scan the vertical transparent electrodes, and then receives and converts the sensing signals all the time to determine the touch point location according to the components of the distinguishable signals in the sensing signals and does not need to coordinate with synchronization. Therefore, the speed of touch determination can be increased. Those skilled in the art can make modifications or alterations accordingly. For example, in the above embodiment, all of the distinguishable signals f(1)-f(k) are simultaneously coupled to the vertical transparent electrodes Tc(1)-Tc(k). However, in other embodiment, portions of the distinguishable signals f(1)-f(k) can be simultaneously coupled to a part of vertical transparent electrodes in the vertical transparent electrodes Tc(1)-Tc(k) in batches, as long as distinguishable signals are simultaneously coupled and the components of the distinguishable signals can be analyzed to achieve the effect of increasing the speed of touch determination. Besides, the above embodiment includes one signal generator 302, one analog to digital converter 304, and one calculating unit 306 for illustrating respective functions. However, in other embodiment, a plurality of signal generators, a plurality of analog to digital convertors, and a plurality of calculation units can also be implemented to achieve respective functions by a manner of processing the corresponding transparent electrodes respectively or by a manner of processing all of the corresponding transparent electrodes cooperatively.

Moreover, in the above embodiment, the distinguishable signals f(1)-f(k) are illustrated by an example of the periodic wave signals of the sine waves. However, in other embodiment, the periodic wave signals can be triangle waves, square waves, or other periodic waveforms with a main frequency. When the above distinguishable signals f(1)-f(k) are implemented by the periodic wave signals, the frequency components are analyzed by discrete fourier transform (DFT) or fast fourier transform (FFT) to determine the touch points. However, in other embodiment, the distinguishable signals f(1)-f(k) can also be implemented by the orthogonal signals, and the touch points can be determined according to the orthogonality (for example, signals with the same frequency and the phase difference of 90 degree can be determined by the orthogonality). Besides, the distinguishable signals f(1)-f(k) can also be implemented by the signals with other distinguishable characteristics, and the touch points can be determined according to the distinguishable characteristic.

In addition, because of the mechanical characteristics, such as the amount of stray capacitance etc, the signals of the specific frequency on the specific location of the transparent electrodes can attenuate or amplify the sensing signals. Therefore, in addition to the distinguishable signals f(1)-f(k) simultaneously coupled to the vertical transparent electrodes Tc(1)-Tc(k) in the above fixed order, in other embodiment, an order of the distinguishable signals f(1)-f(k) simultaneously coupled to vertical transparent electrodes Tc(1)-Tc(k) can be dynamically allocated. For example, at first time point, an order of the distinguishable signals f(1), f(2), . . . f(k) is coupled to the vertical transparent electrodes Tc(1)-Tc(k), and at second time point, an order of the distinguishable signals f(2), f(3), . . . f(k), f(1) is coupled to the vertical transparent electrodes Tc(1)-Tc(k). As a result, the signals of the specific frequency can be prevented from coupling to the specific location of the transparent electrodes continuously, which attenuates or amplifies the sensing signals.

Furthermore, the analog to digital converter 304 can be implemented by a flash analog to digital converter, a successive approximation analog to digital converter, or a sigma-delta analog to digital converter. The calculating unit 306 can be implemented by a CPU/RAM base calculating unit (e.g. microprocessor) or a specific functions calculating unit (e.g. utilizing hardware to implement discrete fourier transform, fast fourier transform, other time-domain to frequency-domain transform, or other calculation for determining components of distinguishable signals f(1)-f(k) in the sensing signals s(1)′-s(j)′).

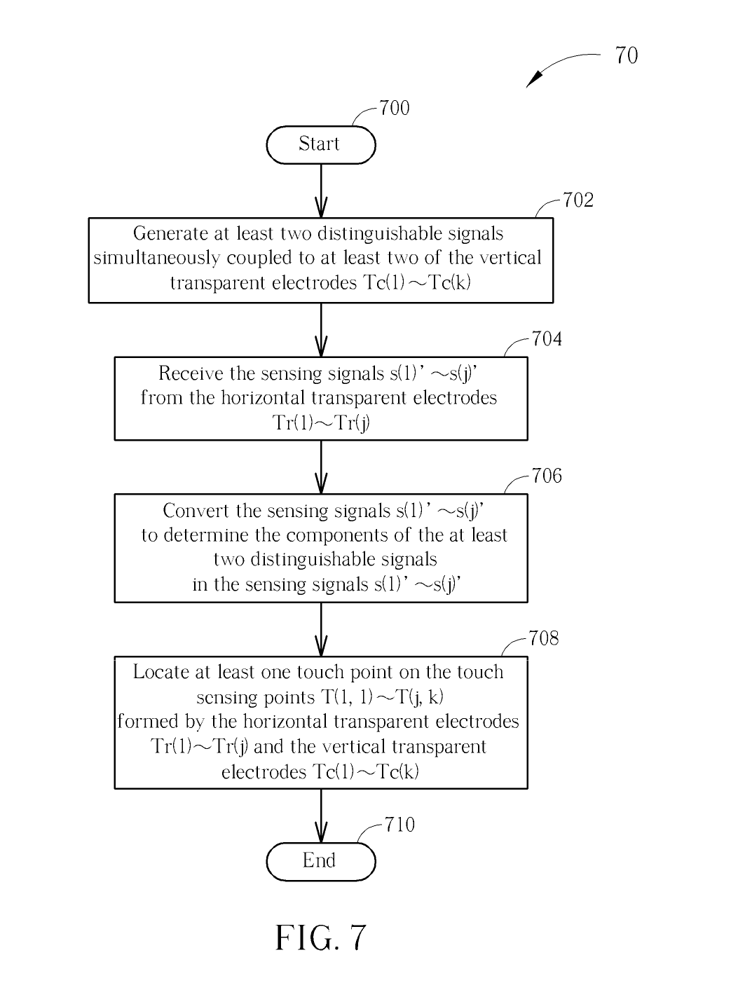

Therefore, the touch point locating operation of the touch sensing device 30 can be summarized in a touch point locating process 70, as shown in FIG. 7, and the touch point locating process 70 further includes the following steps:

Step 700: Start.

Step 702: Generate at least two distinguishable signals simultaneously coupled to at least two of the vertical transparent electrodes Tc(1)-Tc(k).

Step 704: Receive the sensing signals s(1)′-s(j)′ from the horizontal transparent electrodes Tr(1)-Tr(j).

Step 706: Convert the sensing signals s(1)′-s(j)′ to determine the components of the at least two distinguishable signals in the sensing signals s(1)′-s(j)′.

Step 708: Locate at least one touch point on the touch sensing points T(1,1)-T(j,k) formed by the horizontal transparent electrodes Tr(1)-Tr(j) and the vertical transparent electrodes Tc(1)-Tc(k).

Step 710: End.

Detailed description of the touch point locating process 70 can be referred from the foregoing description and are not narrated herein for brevity.

In the prior art, the conventional touch sensing device 10 performs time-domain scanning locating, since the conventional touch sensing device 10 needs to utilize the scanning clock signals w(1)-w(k) to scan the vertical transparent electrodes Tc(1)-Tc(k) one by one and needs to capture information of the sensing signals s(1)˜s(j) in coordination with the timing synchronization signal Syn, the determining speed is slow and the sensing signals are easy to be interfered. In comparison, the present invention simultaneously couples the distinguishable signals to the vertical transparent electrodes and does not need to sequentially scan the vertical transparent electrodes, and then receives and converts the sensing signal all the time to determine the location of the touch point according to the components of the distinguishable signals and does not need to coordinate with synchronization. Therefore, the speed of touch determination can be increased.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A touch sensing device comprising:
a touch sensing panel, comprising a plurality of first dimensional transparent electrodes and a plurality of second dimensional transparent electrodes, for forming a plurality of touch sensing points;
one or more signal generators, for generating at least two orthogonal signals simultaneously coupled to at least two of the plurality of first dimensional transparent electrodes;
one or more analog to digital converters(ADC), coupled to the plurality of second dimensional transparent electrodes, for receiving a plurality of sensing signals from the plurality of second dimensional transparent electrodes; and
one or more calculating units, for converting the plurality of sensing signals, to determine components of the at least two orthogonal signals in the plurality of sensing signals and locate at least one touch point on the plurality of touch sensing points.

2. The touch sensing device of claim 1, wherein the at least two orthogonal signals are simultaneously coupled to each of the plurality of first dimensional transparent electrodes.

3. The touch sensing device of claim 1, wherein the one or more analog to digital converters receive the plurality of sensing signals from the plurality of second dimensional transparent electrodes all the time.

4. The touch sensing device of claim 1, wherein the at least two orthogonal signals are orthogonal to each other.

5. The touch sensing device of claim 1, wherein the at least two orthogonal signals comprise periodic wave signals with different frequencies.

6. The touch sensing device of claim 1, wherein the at least two orthogonal signals comprise periodic wave signals with a same frequency and a phase difference of 90 degree.

7. The touch sensing device of claim 1, wherein an order of the at least two orthogonal signals simultaneously coupled to at least two of the plurality of first dimensional transparent electrodes is dynamically allocated.

8. The touch sensing device of claim 1, wherein the at least two orthogonal signals have periodic waveforms with a main frequency, such as sine waves, triangle waves, or square waves.

9. The touch sensing device of claim 1, wherein the one or more analog to digital converters are flash analog to digital converters, successive approximation analog to digital converters, or sigma-delta analog to digital converters.

10. The touch sensing device of claim 1, wherein the one or more calculating units are CPU/RAM base calculating units or specific function calculating units.

11. A touch sensing device comprising:
a touch sensing panel, comprising a plurality of first dimensional transparent electrodes and a plurality of second dimensional transparent electrodes, for forming a plurality of touch sensing points;
one or more signal generators, for generating at least two periodic wave signals simultaneously coupled to at least two of the plurality of first dimensional transparent electrodes;
one or more analog to digital converters(ADC), coupled to the plurality of second dimensional transparent electrodes, for receiving a plurality of sensing signals from the plurality of second dimensional transparent electrodes; and
one or more calculating units, for converting the plurality of sensing signals, to determine components of the at least two periodic wave signals in the plurality of sensing signals and locates at least one touch point on the plurality of touch sensing points.

12. The touch sensing device of claim 11, wherein the at least two periodic wave signals are simultaneously coupled to each of the plurality of first dimensional transparent electrodes.

13. The touch sensing device of claim 11, wherein the one or more analog to digital converters receive the plurality of sensing signals from the plurality of second dimensional transparent electrodes all the time.

14. The touch sensing device of claim 11, wherein the at least two periodic wave signals are orthogonal to each other.

15. The touch sensing device of claim 11, wherein the at least two periodic wave signals comprise periodic wave signals with different frequencies.

16. The touch sensing device of claim 11, wherein the at least two periodic wave signals comprise periodic wave signals with the same frequency and a phase difference of 90 degree.

17. The touch sensing device of claim 11, wherein an order of the at least two periodic wave signals simultaneously coupled to at least two of the plurality of first dimensional transparent electrodes is dynamically allocated.

18. The touch sensing device of claim 11, wherein the at least two periodic wave signals waveform have periodic waveforms with a main frequency, such as sine waves, triangle waves, or square waves.

19. The touch sensing device of claim 11, wherein the one or more analog to digital converters are flash analog to digital converters, successive approximation analog to digital converters, or sigma-delta analog to digital converters.

20. The touch sensing device of claim 11, wherein the one or more calculating units are CPU/RAM base calculating units or specific function calculating units.

21. A touch point locating method, for a touch sensing device, comprising:
generating at least two distinguishable signals simultaneously coupled to at least two of a plurality of first dimensional transparent electrodes;
receiving a plurality of sensing signals from a plurality of second dimensional transparent electrodes;
converting the plurality of sensing signals, to determine components of the at least two distinguishable signals in the plurality of sensing signals; and
locating at least one touch point on a plurality of touch sensing points formed by the plurality of first dimensional transparent electrodes and the plurality of second dimensional transparent electrodes.

22. The touch point locating method of claim 21, wherein the step of generating at least two distinguishable signals simultaneously coupled to at least two of a plurality of first dimensional transparent electrodes comprises:
generating at least two distinguishable signals simultaneously coupled to each of the plurality of first dimensional transparent electrodes.

23. The touch point locating method of claim 21, wherein the step of receiving the plurality of sensing signals from the plurality of second dimensional transparent electrodes comprises:
receiving the plurality of sensing signals from the plurality of second dimensional transparent electrodes all the time.

24. The touch point locating method of claim 21, wherein the at least two distinguishable signals are orthogonal to each other.

25. The touch point locating method of claim 21, wherein the at least two distinguishable signals comprise periodic wave signals with different frequencies.

26. The touch point locating method of claim 21, wherein the at least two distinguishable signals comprise periodic wave signals with a same frequency and a phase difference of 90 degree.

27. The touch point locating method of claim 21, further comprising:
allocating dynamically an order of the at least two distinguishable signals simultaneously coupled to at least two of the plurality of first dimensional transparent electrodes.

28. The touch point locating method of claim 21, wherein the at least two periodic wave signals waveform have periodic waveforms with a main frequency, such as sine waves, triangle waves, or square waves.
